(19) United States
(12) Patent Application Publication
(10) Pub. No.: US 2010/0237602 A1
(43) Pub. Date: Sep. 23, 2010

(54) Advertising/promotional display system

(76) Inventor: Rod Castello, Studio City, CA (US)

Correspondence Address: Melvin I. Stoltz, 51 Cherry Street, Milford, CT, 06460, US

(21) Appl. No.: 12/661,347

(22) Filed: Mar. 15, 2010

Related U.S. Application Data
(60) Provisional application No. 61/210,310, filed on Mar. 17, 2009.

(51) Int. Cl. B42D 15/00

(52) U.S. Cl. 283/56

(57) ABSTRACT

By providing a housing and a cooperating slider mounted in the housing, with the slider being movable between two alternate positions which cause graphic elements displayed in one position to be completely changed in the second position, a unique, visually exciting and interest generating advertising/promotional product is attained. In the preferred invention, the slider incorporates pre-printed graphic elements formed thereon which are movable between two alternate positions. In the preferred construction, in a first position, two separate and distinct graphic elements are prominently displayed in association with the front and the rear of the housing. In addition, in a second position, the original two graphic elements disappear from view, and are replaced by six new separate and distinct graphic elements, with three of said graphic elements appearing in association with the front of the housing and the remaining three graphic elements appearing in association with the rear of the housing.

### RELATED APPLICATIONS

This application is related to U.S. Provisional Patent Application Ser. No. 61/210,310, filed Mar. 17, 2009 entitled ADVERTISING/PROMOTIONAL DISPLAY SYSTEM.

### TECHNICAL FIELD

This invention relates to advertising/promotional display systems and, more particularly, to advertising/promotional display systems for providing visually exciting and interest generating products.

### BACKGROUND ART

With the ever-increasing quantity of products and services being offered to consumers, substantial interest has been given to promotional systems for advertising such products and services. In this regard, a wide variety of advertising displays and promotional literature has been created and distributed to consumers. However, due to the deluge of material to which average consumers are constantly exposed, greater emphasis has been placed on developing eye-catching visual displays and promotional material which stand out as being visually unique in order to receive consumer attention.

Although various novelty products and printed displays have been created in an attempt to satisfy this demand, these prior art products have failed to provide the desired interest generating result with production costs which advertisers are capable of justifying. In attempting to generate a unique advertising display, some prior art products have employed complex folding systems which produce a three-dimensional display when activated or unfolded.

In spite of the unique visual appearance generated by such products, the overall cost of production and complexity of the assembly of these systems has prevented such prior art systems from becoming popular. In particular, many prior art systems require multi-part segments to be aligned or placed in specific registered positions or locations. This requirement is both time consuming and costly.

Other prior art displays have attempted to generate consumer interest by providing unique visual images or other indicia as an integral part of the display. However, these prior art attempts have also failed to generate the consumer interest being sought, largely due to an inability to physically involve the consumer in the promotion or display operation.

Furthermore, the ever increasing consumer demand seeks to obtain promotional products which produce unique and/or surprising results. In this regard, consumers are continuously seeking products which will produce a surprising visual effect when used.

Therefore, it is a principal object of the present invention to provide a printed advertising or promotional product which is capable of being produced at a reasonable cost and provides an exciting, interest generating display.

Another object of the present invention is to provide a printed advertising or promotional product having the characteristic features described above, which enables the consumer to physically control the presentation of the display in a unique, hands-on manner.

Another object of the present invention is to provide a printed advertising or promotional product having the characteristic features described above, which is capable of mass production and assembly.

Another object of the present invention is to provide a printed advertising or promotional product having the characteristic features described above, which is completely produced and assembled without requiring special segment alignment or registration.

A further object in the present invention is to provide a printed advertising or promotional product having the characteristic features described above, which provides a unique, eye-catching, exciting and surprising visual change which is produced in response to action taken by the consumer.

Other and more specific objects will in part be obvious and will in part appear hereinafter.

### SUMMARY OF THE INVENTION

By employing the present invention, all of the difficulties and inabilities of the prior art are eliminated and a unique, hands-on, printed, visually exciting and interest generating advertising/promotional product is attained. This desirable and previously unattainable result is realized in the present invention by providing a unique, pre-printed promotional system which can be produced in a wide variety of alternate forms and/or configurations. However, regardless of the printed form or configuration desired, the promotional system of the present invention employs a housing and a cooperating slider mounted in the housing, with the slider being movable between two alternate positions which cause graphic elements displayed in one position to be completely changed in the second position.

In the basic, principal construction of the present invention, the promotional system comprises two cooperating components which are cooperatively associated to each other in sliding interengagement. Although two components are required for achieving the basic construction, an alternate embodiment of the present invention may incorporate additional components for providing a further enhanced visual impact.

In the preferred embodiment of the basic construction, the promotional system of the present invention incorporates a housing, which is preferably open on both ends, and a slider mounted in the housing and cooperatively associated with the housing for longitudinal, sliding movement therein. In addition, the housing incorporates an elongated central cavity formed therein which longitudinally extends from one open end to the other. In addition, the housing also comprises a centrally disposed cut-out zone formed therein and extending from the front to the rear of the housing.

In order to achieve the desired automatic, surprising, and interest generating transformation of one group of graphic elements into a plurality of different graphic elements, the slider incorporates pre-printed graphic elements formed thereon which are movable between two alternate positions. In the preferred construction, in a first position, two separate and distinct graphic elements are prominently displayed in association with the front and the rear of the housing. In addition, in a second position, the original two graphic elements disappear from view, and are replaced by six new separate and distinct graphic elements, with three of said graphic elements appearing in association with the front of the housing and the remaining three graphic elements appearing in association with the rear of the housing. In this way, a unique, interest generating, and surprising visual display is achieved.

In order to produce the desired transformation of two graphic elements into six separate and distinct graphic elements, the user merely moves the slider longitudinally, relative to the housing. If desired, both ends of the slider can be moved or pulled from the housing in opposite directions in order to achieve the desired system activation. Alternatively, the longitudinal movement of one end of the slider relative to the housing automatically causes the other end of the slider to move outwardly from the housing in an opposite direction. Regardless of which activation method is employed, the slider effectively causes the two preprinted graphic elements to become hidden from view, revealing six, new, separate and distinct graphic elements for enjoyment by the user and/or promotion of any desired product or service.

In the preferred construction of the present invention, the slider comprises an elongated strip of material, which incorporates the desired graphic elements printed thereon, and is constructed with a folded segment formed substantially midway along the length thereof. In addition, the slider is mounted in cooperating association with the housing, positioned for longitudinal movement within the elongated central cavity formed in the housing. Furthermore, the central portion of the slider is cooperatively associated with the cut out zone formed in the housing.

By longitudinally moving the slider relative to the housing, the elongated length thereof becomes extended, due to the opening of the folded segment, with one end of the slider moving outwardly from the top of the housing, while the other end of the slider moves outwardly from the bottom of the slider. As it is more fully detailed below, this result is achieved by affixing a portion of the slider to a portion of the housing.

By mounting the slider in cooperation with the housing, the longitudinal movement of the slider relative to the housing causes the graphic elements which appear in the slider's first position to become hidden between the panels forming the housing when the slider is in its second position. As a result, the graphic elements appearing on the front and rear surfaces of the slider when the slider is in its first position disappear from view when the slider is moved into its second position.

In addition, when the slider is moved into its second position, the terminating ends of the slider at both the top and bottom of the housing appear for the first time, revealing the graphic elements printed thereon for the first time. In this way, four new, separate and independent graphic elements are visually presented. In addition, two additional graphic elements formed in the folded portion of the slider are revealed when the slider is moved into its second position, thereby enabling all six of the separate and independent graphic elements to become visually revealed for the first time. In this way, six separate and independent graphic elements are alternately displayed in a manner which provides the desired surprise and interest to the consumer as is sought by the sponsor of the promotional system.

As detailed herein, a single, and elongated, folded slider mounted in cooperating association with the housing has been found to provide the desired goals and objectives of the present invention while also forming the basis of the preferred construction. However, if desired, alternate constructions and configurations can be implemented without departing from the scope of this invention.

In this regard, a plurality of slider configurations and structures can be mounted in the single housing in order to provide the desired longitudinal movement between a first and a second position. In addition, apertures, windows, or display zones can be formed in the housing in numerous alternate sizes and shapes in cooperating relationship with the graphic elements of the slider and in a wide variety of alternate positions and configurations. In this way, the present invention can be configured for enabling the graphic elements to be displayed in any desired position or location. However, regardless of the configuration or construction employed it is intended that all variations manufactured in accordance with the present invention are included within the scope of this invention.

In order to further enhance the advertising/promotional display system of the present invention, the housing preferably incorporates preprinted information which is displayed in an exciting and interest generating manner. As a result, any information or message desired by the sponsor of the promotional display system is conveyed to the consumer in an attractive, exciting, and interesting manner. Furthermore, the incorporation of the graphic display elements on the slider further enhances the excitement and interest of the user or consumer. As a result, an exciting promotional display system is realized which overcomes the prior art drawbacks and difficulties.

The invention accordingly comprises an article of manufacture possessing the features, properties, and relation of elements which will be exemplified in the article hereinafter described, and the scope of the invention will be indicated in the claims.

### THE DRAWINGS

For a fuller understanding of the nature and objects of the present invention, reference should be had to the following detailed description taken in connection with the accompanying drawings, in which:

FIG. 1 is a front perspective view of the promotional display system of the present invention shown in its unactivated configuration;

FIG. 2 is a rear perspective view of the promotional display system of the present invention shown in its unactivated configuration;

FIG. 3 is a cross-sectional side elevation view of the promotional display system of the present invention shown in the process of moving between its unactivated configuration and its fully activated configuration;

FIG. 4 is a front perspective view of the promotional display system of the present invention in the process of moving between its unactivated configuration and is fully activated configuration;

FIG. 5 is a front perspective view of the promotional display system of the present invention shown in its fully activated configuration;

FIG. 6 is a rear perspective view of the promotional display system of the present invention in the process of moving between its unactivated configuration and its fully activated configuration; and

FIG. 7 is a rear perspective view of the promotional display system of the present invention shown in its fully activated configuration.

### DETAILED DESCRIPTION

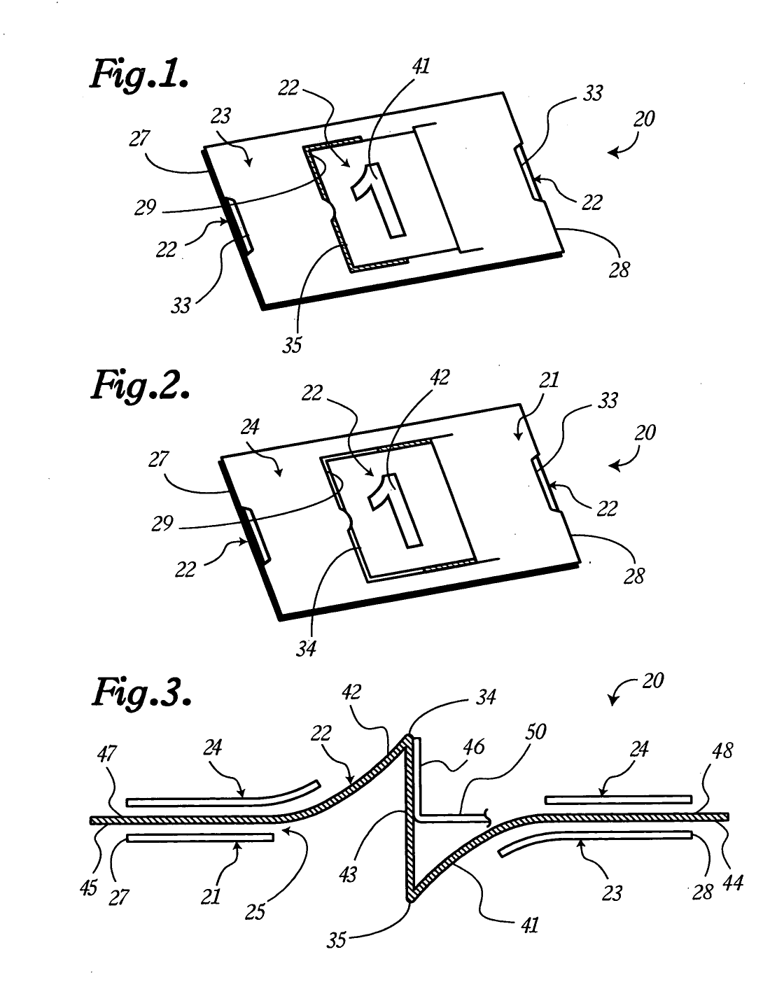

By referring to FIGS. 1-7, along with the following detailed discussion, the construction and operation of the preferred embodiment of the promotional system of the present invention can best be understood. Although the preferred construction of the present invention is detailed herein, alternate constructions and configurations of the present invention can be implemented without deviating from the scope of the present invention. Consequently, it is to be understood that the following detailed disclosure, along with the drawings provided, are for exemplary purposes only and are not intended as a limitation of the present invention.

In FIGS. 1-7, the preferred embodiment of promotional system 20 of the present invention is fully depicted. In this preferred embodiment, promotional system 20 comprises housing 21 with elongated, longitudinally extending, sliding plate or panel 22 cooperatively associated therewith. In its preferred construction, housing 21 comprises a unitary structure formed by front panel 23 and rear panel 24 which are interconnected to each other along their side edges, forming elongated, central cavity or interior zone 25 therebetween.

Furthermore, in its preferred construction, housing 21 incorporates open ends 27 and 28 which provide the entry portals to elongated central cavity/interior zone 25. Finally, housing 21 also incorporates cutout zone or window 29 formed in front panel 23 and extending from front panel 23 through to rear panel 24.

By employing this construction for housing 21 and positioning sliding plate/panel 22 in cavity/interior zone 25, the preferred construction for promotional system 20 is achieved. As is fully detailed herein, by employing these components, a unique, interest generating, consumer controlled promotional system is realized which is capable of delivering any desired message with substantially enhanced impact and excitement.

Furthermore, the pre-printed promotional display system of the present invention automatically transforms one group of graphic elements into a plurality of different groups of graphic elements by merely moving sliding plate/panel 22 in one direction. In this way, the user is able to control the presentation of the preprinted graphic elements and the movement of the graphic elements between the two alternate presentations provided by display system 20. As a result, the user is able to control the movement of promotional display system 20 between its two alternate positions, while also enjoying the resulting graphic displays.

In the preferred construction of the present invention, housing 21 preferably comprises any desired indicia printed on the exposed surfaces of front panel 23 and rear panel 24. In this way, the sponsor of promotional display system 20 can provide any desired information, graphics, alphanumeric configurations, and the like, to the user which are desired to be communicated. Typically, the graphic material and/or indicia printed on front panel 23 and rear panel 24 is designed to be consistent with or complementary to the indicia and/or graphic material printed on sliding plate/panel 22.

As fully depicted in FIGS. 1-7, and best seen in FIG. 3, elongated sliding plate/panel 22 comprises a single strip of material incorporating fold lines 34 and 35 formed along the length thereof. Furthermore, sliding plate/panel 22 is movable between a first, folded, compact position, as shown in FIGS. 1 and 2, and a second, unfolded, fully extended position, as shown in FIGS. 5 and 7. By repeatedly moving sliding plate/panel 22 between its two alternate positions, the plurality of images, graphics, and indicia, alphanumeric configurations, and the like, printed on sliding plate/panel 22 are able to be repeatedly altered and displayed. In this way, the desired graphic information is presented to the user and easily changed between the two alternate presentations.

In the preferred construction, as shown in FIGS. 1 and 2, sliding plate/panel 22 incorporates image 41 printed on the front surface thereof and image 42 printed on the rear surface thereof. In addition, images 41 and 42 are positioned for being displayed through cutout zone 29 formed in housing 21. As a result, whenever sliding plate/panel is in its first, compact, unfolded configuration, images 41 and 42 are fully visible.

Furthermore, if desired by the sponsor of promotional display system 20, additional images, graphics, alphanumeric designations, and the like, are printed on front panel 23 and rear panel 24 of housing 21 in order to further enhance the visual impact, excitement, and interest provided by display system 20 to the user. In the preferred construction, this printed information complements and is consistent with the visual images printed on sliding plate/panel 22 which are visible to the user when sliding plate/panel 22 is in its first position as well as in its second position.

Whenever desired by the user, promotional display system 20 is activated by grasping one end of sliding plate/panel 22 at either open end 27 or 28 of housing 21 and longitudinally withdrawing sliding plate/panel 22 from central cavity/interior zone 25 of housing 21. Although both opposed ends of sliding plate/panel 22 can be grasped by the user at both ends of central cavity/interior zone 25, the movement of one end of sliding plate/panel 22 automatically causes the opposed end to move simultaneously therewith. Consequently, movement of both ends of sliding plate/panel 22 is not required, but may be implemented by the user, if so desired.

In this regard, in order to facilitate the ease of access to both terminating ends or edges of sliding plate/panel 22, front panel 23 and rear panel 24 each comprise cut away zone 33 formed along ends 27 and 28. In this way, the user can quickly and easily grasp a portion of the terminating edge of sliding plate/panel 22 and longitudinally move sliding plate/panel 22 in the desired direction.

Whenever the user wishes to activate promotional display system 20, one terminating edge, or both terminating edges, of sliding plate/panel 22 is grasped and longitudinally moved outwardly from housing 21. As discussed above, if one terminating edge of sliding plate/panel 22 is longitudinally moved outwardly from housing 21, the opposed terminating edge automatically moves outwardly from housing 21, in the opposite direction.

Furthermore, as shown in FIGS. 5 and 7, the longitudinal movement of sliding plate/panel 22 of housing 21 causes the pre-printed images printed on sliding plate/panel 22 to be, automatically revealed. In this regard, the front surface of sliding plate/panel 22 incorporates images 43, 44, and 45, while the rear surface of sliding plate/panel 22 incorporates images 46, 47, and 48. When sliding plate/panel 22 has been fully withdrawn from housing 22, all of the images printed thereon become fully displayed to the user, with images 43 and 46 automatically replacing images 41 and 42 which were previously displayed in cutout zone/window 29.

One of the unique features of the present invention is the construction of sliding plate/panel 22 in its cooperative engagement with housing 21. By employing this preferred construction, sliding plate/panel 22 continuously displays images 41 and 42 in cutout zone/window 29 when sliding plate/panel 22 is in its first, folded, non-extended position. In addition, sliding plate/panel 22 automatically hides images 41 and 42 when sliding plate/panel 22 is extended into its second, unfolded position, while simultaneously revealing and displaying images 43 and 46 in cutout zone/window 29. Furthermore, images 44, 45, 46, and 47 are also automatically revealed when sliding plate/panel 22 is in its second, fully extended position.

In order to achieve the unique, automatic removal or disappearance of images 41 and 42 whenever sliding plate/panel 22 is moved from its first position to its second position, sliding plate/panel 22 is mounted to housing 21 in a unique, interactive and cooperating manner. In this regard, when cutout zone/window 29 is formed in front panel 23 and rear panel 24 of housing 21, the window forming portion of rear panel 24 is removed in its entirety, while the window forming portion of front panel 23 is retained to form folded panel 50.

Thereafter, sliding plate/panel 22 is inserted into central cavity/interior zone 25 of housing 21, with folded panel 50 being affixed to the surface of sliding plate/panel 22 in cooperating relationship with fold line 34. In this way, sliding plate/panel 22 is secured to housing 21 substantially midway along the length thereof, enabling sliding plate/panel 22 to pivot about fold lines 34 and 35 and move in opposite directions whenever sliding plate/panel 22 is activated from its first, folded position into its second, unfolded and fully extended position.

In addition, in order to provide the desired exciting and interest generating display to the user, the front surface of plate/panel 22 is printed with image 43, while folded panel 50 is printed with image 46 and then affixed to sliding plate/panel 22. Since panel 50 is affixed to sliding plate/panel 22 and is constructed for moving from a folded configuration, whenever sliding plate/panel 22 is in its first folded, stowed position, into an unfolded, fully displayed position, whenever sliding plate/panel 22 is moved into its second, unfolded position, image 46 printed on folded panel 50 remains hidden from view when plate/panel 22 is stowed within housing 21 and becomes fully revealed and displayed when plate/panel 22 is longitudinally extended outwardly from housing 21. In this way, the desired exciting and interest generating visual display is achieved. Furthermore, images 41 and 42 become hidden from view, since they are stored within housing 21 when plate/panel 22 is fully extended.

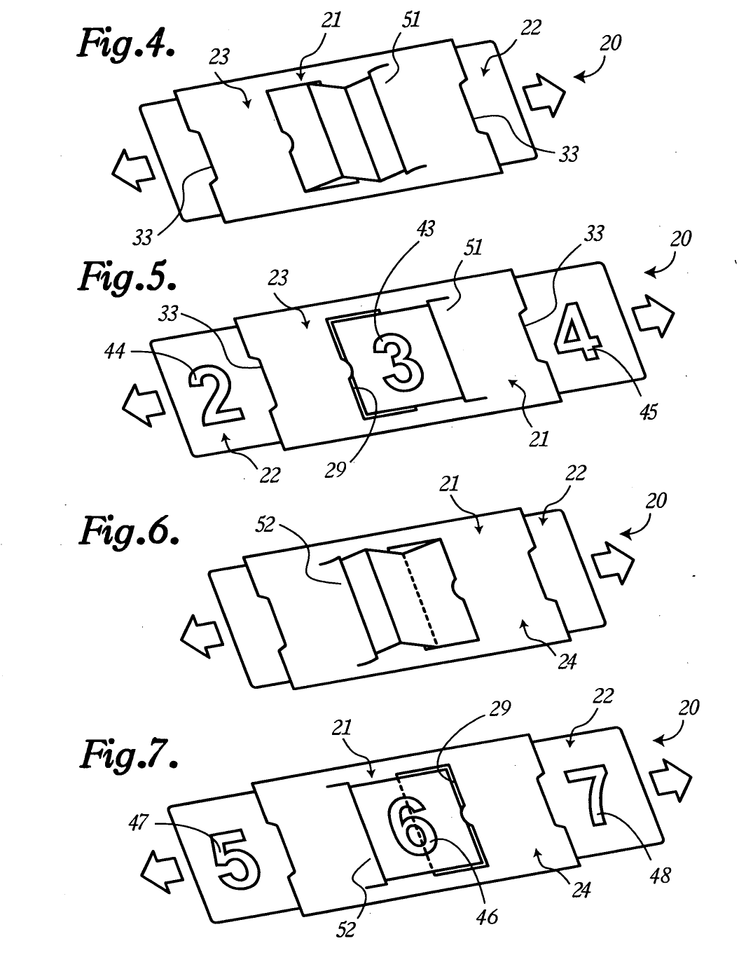

As best seen in FIGS. 4-7, promotional display system 20 of the present invention incorporates flaps 51 and 52 formed in housing 21 in order to provide sliding plate/panel 22 with the ability to arcuately pivot about fold lines 34 and 35 for smoothly moving between its first and second positions. In this regard, front panel 23 incorporates flaps 51 formed therein by cutting slits in front panel 23, while rear panel 24 incorporates flaps 52 by forming slits therein.

By incorporating flap 51 in front panel 23 and flap 52 in rear panel 24, sliding plate/panel 22 is able to freely extend outwardly from housing 21 through window 29 as sliding plate/panel 22 moves between its two alternate positions due to the ability of flaps 51 and 52 extending outwardly simultaneously therewith. In this way, unwanted binding or jamming of sliding plate/panel 22 during its movement is prevented. As a result, sliding plate/panel 22 is able to freely move between its two alternate positions, quickly and easily, thereby providing the user with interest and excitement by controllably moving promotional display system 20, as well as being visually excited and interested by the changing graphics provided thereby.

It will thus be seen that the objects set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described my invention, what I claim as new and desire to secure by Letters Patent is:

1. An advertising/promotional display system comprising:
A) a housing comprising a front panel and a rear panel, with each of said panels having an exposed surface on which indicia may be displayed;
B) said panels being positioned in overlying relationship with each other and affixed to each other along cooperating side edges thereof, defining therebetween an elongated, longitudinally extending central cavity having a first and a second entry/exit portal formed on the opposed ends of said housing;
C) a first cut out zone formed in the front panel and a second cut out zone formed in the rear panel, said first and second cut out zones being positioned in cooperating alignment with each other; and
D) an elongated, longitudinally extending sliding plate
a) mounted between the front panel and the rear panel,
b) positioned in the elongated, longitudinally extending central cavity formed between said front panel and rear panel with a portion of said sliding plate being visible through the first cut out zone and the second cut out zone,
c) constructed for being longitudinally movable in said housing from a first compact position to a second, extended, fully displayed position, and
d) comprising a first portion with indicia formed thereon, said first portion and said indicia being visible through the first cut out zone when said sliding plate is in its first compact position, and a second portion with indicia formed thereon, said second portion and indicia being visible through the second cut out zone when said sliding plate is in its first compact position; and
e) comprising a third portion with indicia formed thereon, said third portion and said indicia being visible through the first cut out zone when said sliding plate is in its second, fully extended position, and a fourth portion with indicia formed thereon, said fourth portion and said indicia being visible through the second cut out zone when the sliding plate is in its second, fully extended position;
whereby movement of the slider plate relative to the housing causes the indicia formed on the sliding plate to be automatically changed.

2. The advertising/promotional display system defined in claim 1, wherein said elongated longitudinally extending sliding plate is further defined as comprising a first portion formed at one end of said sliding plate and a second end portion formed at an opposed end of the sliding plate and indicia formed on said first and second end portions of the sliding plate, said first and second portions being maintained in the housing when the sliding plate is in its first position and become displayed when said sliding plate is moved into its second, fully extended, displayed position, with said first and second end portions of the sliding plate extending outwardly from the first and second entry/exit portals of the central cavity for displaying the indicia printed thereon.

3. The advertising/promotional display system defined in claim 2, wherein said elongated, longitudinally extending sliding plate is further defined as being folded along its length for enabling the sliding plate to move between the first, compact, folded configuration into its second, extended, fully displayed and unfolded position, wherein the first end portion of the sliding plate extends from the first entry/exit portal and the second end portion of the sliding plate extends from the second entry/exit portal.

4. The advertising/promotional display system defined in claim 3, wherein a section of the sliding plate is secured to a section of the housing directly adjacent to the first cut out zone and the second cut out zone, thereby enabling the first end portion of the sliding plate to move in a first direction when withdrawn from the entry/exit portal of the housing while the second end portion of the sliding plate moves in the opposite direction when withdrawn from the opposite entry/exit portal.

5. The advertising/promotional display system defined in claim 4, wherein the first portion of the sliding plate articulately pivots in a first direction whenever said first end portion is withdrawn from the housing and the second portion of the sliding plate articulately pivots in a second, generally opposite direction whenever the second end portion of the sliding plate is withdrawn from the housing, thereby enabling both the first portion and second portion of the sliding plate to move in opposite directions while being affixed to the housing substantially midway along its length.

6. The advertising/promotional display system defined in claim 5, wherein the withdrawal movement of the first end portion causes the first portion and the indicia formed thereon to be moved into the housing, thereby preventing its visibility, while the simultaneous withdrawal movement of the second end portion causes the second portion and the indicia formed thereon to be moved into the housing for preventing its visibility.

7. The advertising/promotional display system defined in claim 6, wherein the arcuate pivoting movement of the first portion causes the third portion with the indicia formed thereon to be displayed in the first cut out zone, while the arcuate pivoting movement of the second portion causes the fourth portion with the indicia formed thereon to be displayed in the second cut out zone.

8. The advertising/promotional display system defined in claim 5, wherein the front panel of the housing is further defined as comprising a first flap member formed directly adjacent the first cut out zone for cooperating with and enabling the first portion of the sliding plate to arcuately pivot whenever the first end portion of the sliding plate is withdrawn from the housing.

9. The advertising/promotional display system defined in claim 7, wherein the rear panel of the housing is further defined as comprising a second flap member formed directly adjacent to the second cut out zone for cooperating with and enabling the second portion of the sliding plate to arcuately pivot whenever the second end portion of the sliding plate is withdrawn from the housing.

10. The advertising/promotional display system defined in claim 1, wherein the indicia formed on the housing in the sliding plate comprises one or more selected from the group consisting of printed material, messages, colors, slogans, logos, graphics, alphanumerics, cutouts, and shaped objects.

11. The advertising/promotional display system defined in claim 1, wherein the front panel and rear panel of the housing incorporate access zones formed on opposed edges thereof for enabling an individual to easily grasp the sliding plate at both ends of the housing for enabling the sliding plate to be longitudinally moved outwardly from the housing.
